(19) United States
(12) Patent Application Publication
(10) Pub. No.: US 2002/0149257 A1
(43) Pub. Date: Oct. 17, 2002

(54) Spoke and hub assembly

(76) Inventors: James K. Miansian, Lake Forest, CA (US); Mouafak-Chiekh Albasateneh, Santa Ana, CA (US)

Correspondence Address: LAW OFFICES OF ERIC KARICH, 2807 ST. MARK DR., MANSFIELD, TX, 76063, US

(21) Appl. No.: 10/122,449

(22) Filed: Apr. 13, 2002

Related U.S. Application Data
(60) Provisional application No. 60/283,850, filed on Apr. 14, 2001.

(51) Int. Cl. B60B 1/06

(52) U.S. Cl. 301/74

(57) ABSTRACT

A spoke and hub assembly has a wheel rim, a hub, and a plurality of spokes. The hub is positioned within and coaxially aligned with wheel rim, and includes a plurality of spoke locking bores. The plurality of spokes are together adapted to interconnect between the hub and a wheel rim to retain the hub coaxially disposed with respect to the wheel rim. Each of the plurality of spokes includes a locking portion extending from a hub engaging face of an anchor head of each of the plurality of spokes. The locking portion is shaped to lockingly engage a locking slot of a head engaging face of each of a plurality of spoke locking bores. When the locking portion is seated in the locking slot, the locking portion prevents rotation of the spoke with respect to the hub.

### CROSS-REFERENCE TO RELATED APPLICATIONS

This application for a utility patent claims the benefit of U.S. Provisional Application No. 60/283,850, filed Apr. 14, 2001.

### BACKGROUND OF THE INVENTION

1. Field of the Invention

This invention relates generally to a spoke wheel and hub assembly, and more particularly to a spoke wheel and hub assembly that includes a spoke that lockingly engages the hub so that cannot rotate once it has been properly installed.

2. Description of Related Art

The following art defines the present state of this field:

H. H. Baker, U.S. Pat. No. 496,844, teaches an improved spoke and spoke fastening device. The spoke is generally structured like the present invention, extending straight through the hub; however, this spoke is designed to freely turn within the bore through the hub. This reference actually teaches away from the present invention.

Pfundstein, U.S. Pat. No. 4,448,456, teaches a spoke wheel and hub assembly that simulates the popular racing wheels in that it projects a small diameter hub, while providing the requisite load bearing characteristics so necessary with modem day wheels. Structurally, the assembly includes an adaptor removably bolted by appropriate lugs to the brake drum or wheel support plate of an automobile, and the wheel is then detachably mounted on the adaptor member. This reference also teaches a structure in which the spoke freely turns within the bore through the hub.

Behnke, U.S. Pat. No. 5,494,337, teaches a strong, light weight and high performance hub is described for use in a spoked wheel in which the hub is connected to a rim by a plurality of spokes. The hub is provided with two bell-shaped end flanges which are integral. Two rings of bores are defined in each end of the flanges. The bores are paired between the rings, one bore in the outer ring being substantially adjacent to one bore in the adjacent inner ring. The angle of definition of each of the bores in the hub flange tends to orient a spoke disposed therethrough at an angle to a plane perpendicular to the longitudinal axis of the hub of about 20 degrees. When the spoke is attached to the rim, it is gently pulled or bent outward so that the angle to the plane perpendicular to the axis of the hub is reduces or in the illustrated embodiment, reduced to 9 degrees or less. The gentle bend in the spoke prevents the spoke from loosening after the initial truing and tensioning even if the spoke wheel is repeatedly subjected to high impulsive stresses. The hub also provides a light weight, strong and simple assembly for providing bearing support for an axle disposed through the hub.

Bretzm, U.S. Pat. No. 478,394, teaches a bicycle wheel having spokes that attach to spurs extending from the hub. As with the other prior art designs, the spoke is positioned through an orifice that is smooth so as to not impede the turning of the spoke within the orifice.

Watanabe, U.S. Pat. No. 4,618,187, similar to Bretzm, teaches several embodiments of wire wheel arrangements embodying a hub portion, a rim portion and a plurality of spoke pairs for interconnecting the hub and rim portions. In accordance with all embodiments of the invention, the spoke pairs are comprised of ends that are integrally connected by an intermediate portion. The outer ends of the end portions are connected to the rim portion by nipples and the intermediate portion is connected to the hub portion to complete the assembly. Various preferred geometric relationships are disclosed as are arrangements for affixing the intermediate portions to the hub portion.

Choi, U.S. Des. No. 373,102, teaches a spoke having a faceted cross-section that might tend to prevent turning; however, the spoke is bent at the end similar to ordinary bicycle spokes. Such faceting is not shown in a straight spoke, as used in the present invention.

Shermeister, U.S. Pat. No. 5,806,935, teaches a tension-lock system for the spokes of a spoked wheel including a nipple having both internal threads (which mate with the external threads at one end of a spoke) and external threads. A lock-nut having internal threads to mate with the external threads of the spoke nipple, and is at one end convex shaped. A washer which is at one end concave shaped to mate with the convex surface of the nut. As the wheel is being assembled, the lock nut and washer are slid over the threaded end of the spoke. The threaded end of the spoke is then placed through the hole in the rim. The nipple is then threaded onto the threads of the spoke until the wheel is in a “trued position.” The washer and lock nut are then tightened onto the nipple, and against the rim, thus preventing the nipple from turning on the spoke and thereby maintaining the wheel in the “trued position.” Another variation of the tension-lock system for the spoke of a spoked wheel includes a lock nut having internal threads which mate with the external threads at one end of a spoke. A nipple which passes through a hole in the rim of the wheel also includes internal threads which also mate with the spoke threads. The nut locks against one end of the nipple after both nipple and nut have been threaded onto the spoke into a “trued position”, thus preventing the nipple from turning on the spoke and thereby maintaining the spokes in the “trued position.”

A. Meldrum U.S. Pat. No. 1,718,169, teaches a means for securing the outer ends of the spokes to the felloe whereby all of the spokes may first be assembled into a spider, which as a unit may then be inserted into the felloe, the ends of the spokes then being attached to the felloe without the use of any additional fastening means.

A. J. Horling, Jr., U.S. Pat. No. 2,778,690, teaches an invention relating to spoke nipples for bicycle wheels and other spoke wheels and more particularly to a nipple formed of hard material having therein an inset of softer material for receiving the screw threaded end of an associated spoke.

The prior art teaches spokes that are bent and therefore prevent rotation of the spoke with respect to the hub. The prior art also teaches a spoke and spoke fastening device wherein the spoke extends straight through the hub but does not prevent rotation of the spoke with respect to the hub. However, the prior art does not teach a straight spoke that lockingly engages the hub so that the spoke cannot rotate once it has been installed, despite being straight. The present invention fulfills these needs and provides further related advantages as described in the following summary.

### SUMMARY OF THE INVENTION

The present invention teaches certain benefits in construction and use which give rise to the objectives described below.

The present invention provides a spoke and hub assembly that includes a wheel rim, a hub, and a plurality of spokes. The hub is positioned within and coaxially aligned with wheel rim, and includes a plurality of spoke locking bores. The plurality of spokes are together adapted to interconnect between the hub and a wheel rim to retain the hub coaxially disposed with respect to the wheel rim. The plurality of spokes and the hub together include a means for preventing rotation of each of the plurality of spokes with respect to the hub when the spoke is seated in one of the plurality of spoke locking bores.

A primary objective of the present invention is to provide a spoke and hub assembly having advantages not taught by the prior art.

Another objective is to provide a plurality of spokes that interlock with a hub in a manner that prevents rotation of each of the plurality of spokes with respect to the hub.

A further objective is to provide a spoke that has a straight proximal end of the shank portion that is straight, and not bent, so that an anchor head supports the spoke against the hub, as opposed to a bent shank

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of the preferred embodiment of the present invention, a spoke and hub assembly, the assembly including a hub and a plurality of spokes;

FIG. 2 is a side elevational view of one embodiment of the hub, further illustrating a plurality of spoke locking bores;

FIG. 3A is a side elevational view of a first embodiment of one of the plurality of spokes;

FIG. 3B is a top plan view of a first embodiment of one of the plurality of spoke locking bores;

FIG. 4A is a side elevational view of a second embodiment of one of the plurality of spokes;

FIG. 4B is a top plan view of a second embodiment of one of the plurality of spoke locking bores;

FIG. 5A is a side elevational view of a third embodiment of one of the plurality of spokes;

FIG. 5B is a top plan view of a third embodiment of one of the plurality of spoke locking bores;

FIG. 6A is a side elevational view of a fourth embodiment of one of the plurality of spokes;

FIG. 6B is a top plan view of a fourth embodiment of one of the plurality of spoke locking bores;

FIG. 7A is a side elevational view of a fifth embodiment of one of the plurality of spokes;

FIG. 7B is a top plan view of a fifth embodiment of one of the plurality of spoke locking bores;

FIG. 8A is a side elevational view of a sixth embodiment of one of the plurality of spokes;

FIG. 8B is a top plan view of a sixth embodiment of one of the plurality of spoke locking bores; and

FIG. 9 is a perspective view of a first drill and a second drill used in one method of manufacturing the hub.

### DETAILED DESCRIPTION OF THE INVENTION

The above described drawing figures illustrate the invention, a spoke and hub assembly 10 that includes a wheel rim 12 and a hub 20 connected by a plurality of spokes 30. The hub 20 and the plurality of spokes 30 are adapted to interconnect so that none of the plurality of spokes 30 can rotate with respect to the hub 20.

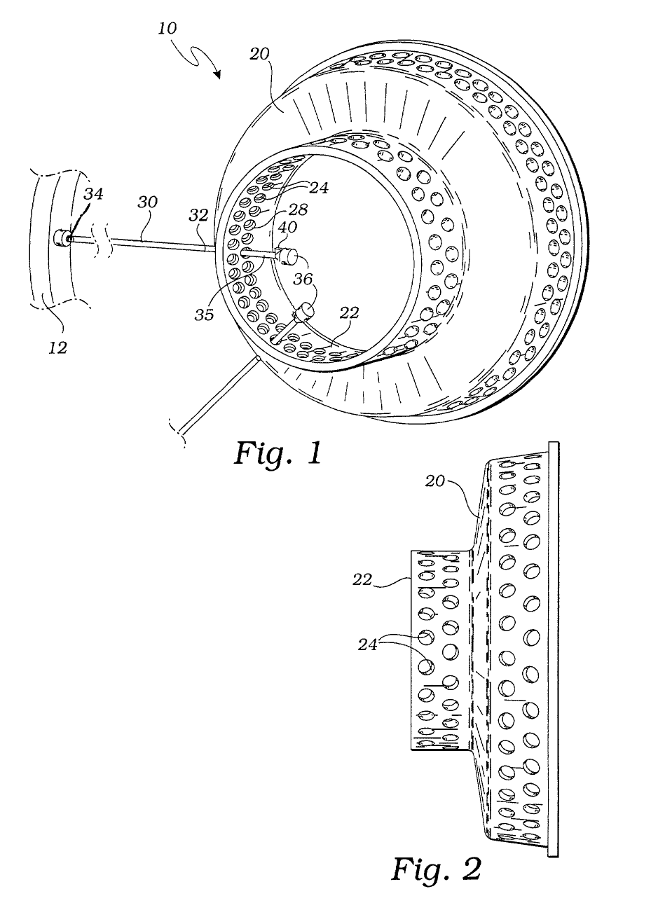

As shown in FIG. 1, the hub 20 is positioned within and coaxially aligned with wheel rim 12, and includes a plurality of spoke locking bores 24, described in greater detail below. The plurality of spokes 30 are together adapted to interconnect between the hub 20 and a wheel rim 12 to retain the hub 20 coaxially disposed with respect to the wheel rim 12. While only two of the plurality of spokes 30 are illustrated, it is understood that the assembly 10 includes many spokes extending through the hub 20. The wheel rim 12 is well known in the prior art, so is not described in greater detail herein. The novelty of the present invention lies in the inclusion of a means for preventing rotation of each of the plurality of spokes with respect to the hub 20 when the spoke is seated in one of the plurality of spoke locking bores.

As shown in FIGS. 1 and 2, the hub 20 includes a generally cylindrical sidewall 22 having a plurality of spoke locking bores 24. Each of the plurality of spoke locking bores 24 includes a head engaging face 26 for contacting an anchor head 36 of one of the plurality of spokes 30, as described below. The head engaging face 26 is preferably at the bottom of a counter-sink 28 designed to snugly receive the anchor head 36 of one of the plurality of spokes 30. The hub 20 is constructed of a strong and rigid material, preferably stainless steel or aluminum.

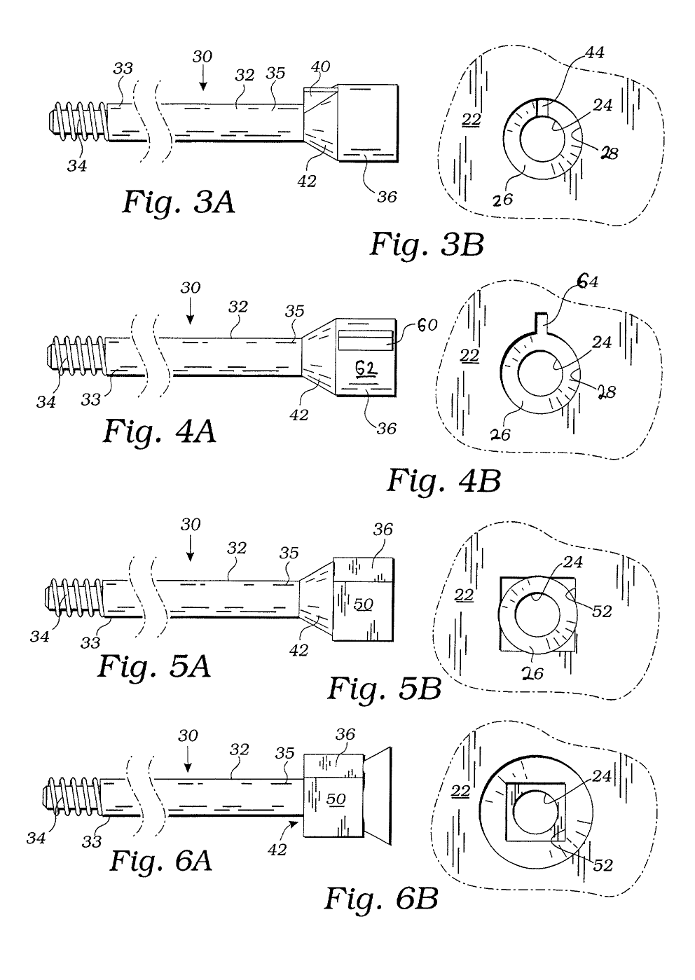

As shown in FIGS. 3A, 4A, 5A, 6A, 7A, and 8A, each of the plurality of spokes 30 includes a shank portion 32 having the anchor head 36 at a straight proximal end 35 and an engaging means 34 for engaging the wheel rim 12 at a distal end 33. While the assembly 10 includes a plurality of spokes 30, for simplicity we will describe only a single spoke 30 and its mating one of the plurality of spoke locking bores 24.

The straight proximal end 35 of the shank portion 32 extends straight from the anchor head 36, preferably as an integral construction. The shank portion 32 of the spoke 30 is elongate and has a diameter of less than the diameter of the spoke locking bore 24. The hub engaging face 42 of the anchor head 36, on the other hand, has a diameter of greater than the diameter of the spoke locking bore 24, thereby enabling a hub engaging face 42 of the anchor head 36 to contact a head engaging face 26 of the spoke locking bore 24 when the spoke 30 is operably inserted through the spoke locking bore 24. It is critical that the straight proximal end 35 of the shank portion 32 be straight so that the anchor head 36 supports the spoke 30 against the hub 20, as opposed to a bent shank portion 32 that itself anchors the spoke 30, as is done in the prior art.

The plurality of spokes 30 are preferably constructed of a strong yet decorative material such as stainless steel, although other materials known in the art can also be utilized.

The spoke 30 includes a means for interlocking with the spoke locking bore 24 when the shank portion 32 is inserted therethrough and the anchor head 36 is seated against the spoke locking bore 24. Those skilled in the art can devise many alternative structures that achieve the goal of this invention, and such obvious and equivalent structures should be considered within the scope of the present invention. Seven different embodiments of the invention are described below.

In a first embodiment, as shown in FIGS. 3A and 3B, the means for interlocking is provided by a locking portion 40 extending from the hub engaging face 42 of the anchor head 36 of each of the plurality of spokes 30. The locking portion 40 is shaped to lockingly engage a locking slot 44 of the head engaging face 26 of each of the plurality of spoke locking bores 24. When the locking portion 40 is seated in the locking slot 44, the locking portion 40 prevents rotation of the spoke 30 with respect to the hub 20.

In a second embodiment, as shown in FIGS. 4A and 4B, the means for interlocking is provided by a locking arm 60 that extends from a side surface 62 of the anchor head 36 of each of the plurality of spokes 30, the locking arm 60 being shaped to lockingly engage with an extended slot 64 extending into the counter-sink 28 of one of the plurality of spoke locking bores 24. When the locking arm 60 is seated in the extended slot 64, the locking arm 60 prevents rotation of the spoke 30 with respect to the hub 20.

In a third embodiment, as shown in FIGS. 5A and 5B, the means for interlocking is provided by a contoured outer surface 50 of the anchor head 36 of each of the plurality of spokes 30. The contoured outer surface 50 is shaped to lockingly engage with a contoured inner surface 52 of one of the plurality of spoke locking bores 24. When the contoured outer surface 50 is seated in the contoured inner surface 52, the contoured outer surface 50 prevents rotation of the spoke 30 with respect to the hub 20. While the present embodiment illustrates the anchor head 36 as having a square shape, many non-cylindrical shapes could be used, including but not limited to triangular, hexagonal, oval, or other faceted or irregular shape.

In a fourth embodiment, as shown in FIGS. 6A and 6B, the hub engaging face 42 of each of the plurality of spokes 30 includes a contoured outer surface 50 similar to the third embodiment. In this embodiment, the contoured inner surface 52 is provided by the head engaging face 26.

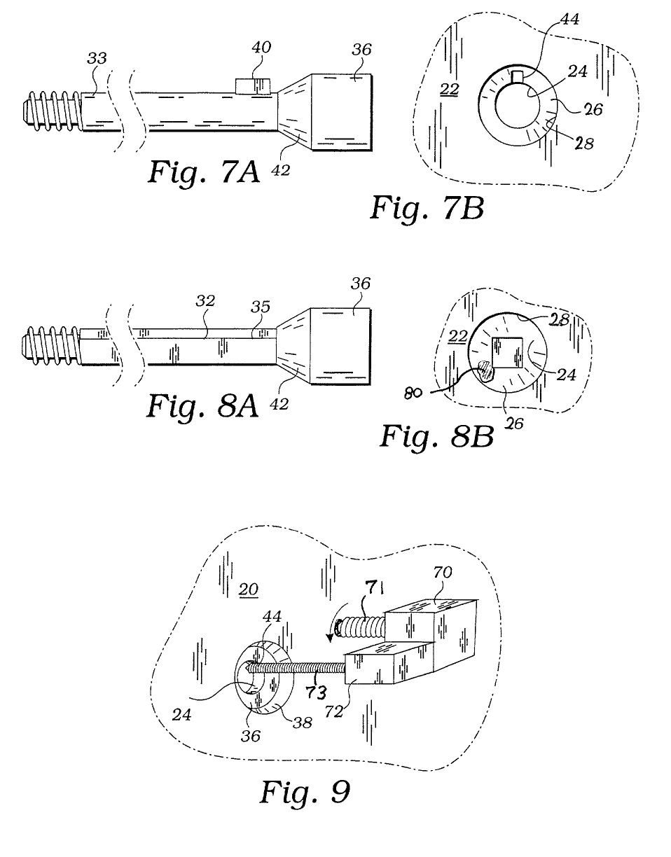

In a fifth embodiment, as shown in FIGS. 7A and 7B, the locking portion 40, similar to the first embodiment, extends from the shank portion 32 of each of the plurality of spokes 30. In this embodiment, the locking slot 44 extends into the spoke locking bore 24.

In a sixth embodiment, as shown in FIGS. 8A and 8B, the shank portion 32 of each of the plurality of spokes 30 has a non-circular cross-section, such as the square shape shown. In this embodiment, the plurality of spoke locking bores 24 are square apertures, or otherwise shaped to mate with the shank portion 32 to prevent rotation of each of the plurality of spokes 30.

In a seventh embodiment, as shown in FIGS. 8A and 8B, the means for preventing rotation is provided by an adhesive 80 that is adapted to lockingly engage the anchor head 36 with one of the plurality of spoke locking bores 24. While this is illustrated as used in conjunction with the shank portion 32 having a non-circular cross-section, it is possible that the adhesive 80 alone could be used to prevent rotation. During assembly of the wheel, the adhesive 80 could be applied to either the hub 20 or the anchor head 36, and would form a powerful bond between the two when connected.

As shown in FIG. 1, the engaging means 34 is preferably an externally threaded portion of the distal end 33 that is adapted to threadedly or otherwise engage the wheel rim 12. Since the engagement of the plurality of spokes 30 to the wheel rim 12 is not important to the present invention, the engaging means 34 is not described in greater detail, but is intended to include all of the various prior art mechanisms known to those skilled in the art.

The invention includes a method of manufacturing the hub 20 described above using a first drill 70 and a second drill 72. The first drill 70 has a first bit 71 adapted to drill one of the spoke locking bores 24 described above. The second drill 72 has a second bit 73 adapted to drill the locking slot 44, or equivalent structure described above. The first drill 70 is positioned for drilling into the hub 20. The second drill 72 is positioned adjacent to the first drill 70 such that when the first drill 70 is positioned for drilling a second of the plurality of spoke locking bores 24, the second drill 72 is positioned for drilling the locking slot 44 of a first of the plurality of spoke locking bores 24. Finally, the position of the second drill 72 is fixed with respect to the first drill 70 such that the first and second drills 70 and 72 remain fixed with respect to each other despite repeated use.

The first and second drills 70 and 72 are then used to drill the plurality of spoke locking bores 24 in the generally cylindrical sidewall 22 of the hub 20. The plurality of spoke locking bores 24 are drilled with the first drill 70. Simultaneously, the second drill 72 cuts the locking slot 44 in each of the plurality of spoke locking bores 24.

In an alternative method, or in addition to one of the above-described structures, the plurality of spoke locking bores 24 or the anchor heads 36 of the plurality of spokes 30 could be coated with the adhesive 80 described above to further restrict the rotation of the plurality of spokes 30 with respect to the hub 20.

While other methods of manufacturing the hub 20 can be used, this method is preferred because it reduces the expense of manufacturing the hub 20. If a separate cutting process is required for each of the plurality of spoke locking bores, the process may be too expensive. The present method, however, teaches a process that does not require a second cutting process, but simply leverages the first cutting process that is already required.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A spoke adapted to connect a hub to a wheel rim, the hub having a plurality of spoke locking bores, the spoke locking bore having a head engaging face, the spoke comprising:
a shank portion having a straight proximal end and a distal end, the shank portion having a diameter of less than the diameter of each of the plurality of spoke locking bores;
an anchor head formed at the straight proximal end, the anchor head having a hub engaging face that has a diameter of greater than the diameter of each of the plurality of spoke locking bores,
the shank portion extending straight from the anchor head such that the hub engaging face can seat against the head engaging face when the spoke is inserted through one of the spoke locking bores;
an engaging means adapted to removably engage the shank portion to the wheel rim; and
a means for preventing rotation of the spoke with respect to the hub when the spoke is seated in one of the plurality of spoke locking bores.

2. The spoke of claim 1 wherein the means for preventing rotation is a locking portion extending from the spoke, the locking portion being adapted to engage a locking slot of the hub when the anchor head is seated in one of the plurality of spoke locking bores.

3. The spoke of claim 2 wherein the locking portion extends from the hub engaging face of the anchor head.

4. The spoke of claim 2 wherein the locking portion is a locking arm that extends from a side surface of the anchor head.

5. The spoke of claim 2 wherein the locking portion extends from the shank portion adjacent the anchor head.

6. The spoke of claim 1 wherein the means for preventing rotation is contoured outer surface of the anchor head that is non-circular in cross section.

7. The spoke of claim 1 wherein the means for preventing rotation is provided by the shank portion having a non-circular cross section.

8. The spoke of claim 1 wherein the means for preventing rotation is provided by an adhesive that is adapted to lockingly engage the anchor head with one of the plurality of spoke locking bores.

9. A spoke and hub assembly comprising:
a wheel rim;
a hub having a plurality of spoke locking bores, the spoke locking bore having a head engaging face, the hub being positioned within and coaxially aligned with wheel rim;
a plurality of spokes, each of the plurality of spokes having a shank portion having a straight proximal end and a distal end, the shank portion having a diameter of less than the diameter of each of the plurality of spoke locking bores; an anchor head formed at the straight proximal end, the anchor head having a hub engaging face that has a diameter of greater than the diameter of each of the plurality of spoke locking bores, the shank portion extending straight from the anchor head;
the distal end of each of the plurality of spokes being attached to the wheel rim;
each of the plurality of spokes being positioned through one of the plurality of spoke locking bores such that the hub engaging face is seated against the head engaging face and the spoke extends the one of the plurality of spoke locking bores; and
a means for preventing rotation of each of the plurality of spokes with respect to the hub.

10. The assembly of claim 9 wherein the means for preventing rotation is a locking portion extending from the spoke, the locking portion being adapted to engage a locking slot of the hub when the anchor head is seated in one of the plurality of spoke locking bores.

11. The assembly of claim 10 wherein the locking portion extends from the hub engaging face of the anchor head.

12. The assembly of claim 10 wherein the locking portion is a locking arm that extends from a side surface of the anchor head.

13. The assembly of claim 10 wherein the locking portion extends from the shank portion adjacent the anchor head.

14. The assembly of claim 9 wherein the means for preventing rotation is contoured outer surface of the anchor head that is non-circular in cross section.

15. The assembly of claim 9 wherein the means for preventing rotation is provided by the shank portion having a non-circular cross section.

16. The assembly of claim 9 wherein the means for preventing rotation is provided by an adhesive that is adapted to lockingly engage the anchor head with one of the plurality of spoke locking bores.

17. A method of manufacturing a hub comprising:
providing a hub having generally cylindrical sidewall;
providing a first drill having a first bit adapted to drill a spoke locking bore;
providing a second drill having a second bit adapted to drill a locking slot;
positioning the first drill for drilling into the hub;
positioning the second drill adjacent to the first drill such that when the first drill is positioned for drilling a second of the plurality of spoke locking bores, the second drill is positioned for drilling the locking slot of a first of the plurality of spoke locking bores; and
fixing the position of the second drill with respect to the first drill such that the first and second drills remain fixed with respect to each other despite repeated use.

18. The method of claim 17 further comprising the steps of: drilling the plurality of spoke locking bores with the first drill, the second drill simultaneously cutting the locking slot in each of the plurality of spoke locking bores.
